(19) United States
(12) Patent Application Publication
(10) Pub. No.: US 2014/0063095 A1
(43) Pub. Date: Mar. 6, 2014

(54) INK JET HEAD

(71) Applicant: Toshiba Tec Kabushiki Kaisha, Tokyo (JP)

(72) Inventors: Shuhei Yokoyama, Shizuoka-ken (JP); Chiaki Tanuma, Tokyo (JP); Ryuichi Arai, Shizuoka-ken (JP); Ryutaro Kusunoki, Shizuoka-ken (JP)

(73) Assignee: Toshiba Tec Kabushiki Kaisha, Tokyo (JP)

(21) Appl. No.: 14/015,700

(22) Filed: Aug. 30, 2013

(30) Foreign Application Priority Data
Aug. 31, 2012 (JP) 2012-191806

(51) Int. Cl. B41J 2/045; B41J 2/16

(52) U.S. Cl. CPC B41J 2/04581; B41J 2/1621
USPC 347/9; 29/25.35

(57) ABSTRACT

An ink jet head according to an embodiment comprises a substrate including a mounting surface and a pressure chamber, a vibration plate including a first surface fixed to the mounting surface and covering the pressure chamber, and a second surface opposite the first surface. The ink jet head further comprises a first electrode on the second surface, a piezoelectric body overlapping the first electrode, a second electrode overlapping the piezoelectric body, and a protective film provided on the second surface. The inkjet head further comprises a nozzle in communication with the pressure chamber and configured to discharge ink, and a drive circuit provided on the mounting surface of the substrate and configured to apply a drive voltage to the first electrode or the second electrode to deform the piezoelectric body and to change a volume of the pressure chamber.

### CROSS-REFERENCE TO RELATED APPLICATION

This application is based upon and claims the benefit of priority from Japanese Patent Application No. 2012-191806, filed on Aug. 31, 2012; the entire contents of which are incorporated herein by reference.

### FIELD

Embodiments described herein relate generally to an ink jet head.

### BACKGROUND

On-demand type ink jet recording methods are known in which ink droplets are discharged from a nozzle according to an image signal, and an image is formed on recording paper by the ink droplets. In connection with the on-demand type ink jet recording method, a heating element type ink jet recording method and a piezoelectric element type ink jet recording method are known.

In the heating element type ink jet recording method, bubbles form within an ink due to a heat provided by a heat source in an ink flow path. The ink is pushed along the path by the bubbles and is discharged from the nozzle.

In the piezoelectric element type ink jet recording method, a pressure change occurs in an ink chamber, where ink is stored, due to the deformation of the piezoelectric element which changes the volume of the ink chamber. The ink is thus discharged from the nozzle.

The piezoelectric element is an electromechanical conversion element. When an electrical field is applied thereto, the piezoelectric element deforms by expansion or shear. Lead zirconate titanate is used as a typical piezoelectric element.

With respect to an ink jet head which uses a piezoelectric element, a configuration using a nozzle plate formed from a piezoelectric material is known. The nozzle plate of the ink jet head, for example, includes an actuator. The actuator includes, for example, a piezoelectric film including a nozzle which discharges ink, and a metal electrode film formed on both surfaces of the piezoelectric film surrounding the nozzle.

The ink jet head has a pressure chamber connected to the nozzle. The ink enters the pressure chamber and the nozzle of the nozzle plate, and is maintained within the nozzle by forming a meniscus within the nozzle. When a driving waveform (a voltage) is applied to the two electrodes provided around the nozzle on either side of the piezoelectric film, an electrical field of the same direction as the direction of the polarization is applied to the piezoelectric film via the electrodes. Accordingly, the actuator expands and contracts in a direction perpendicular to the electrical field direction. The nozzle plate deforms by virtue of this expansion and contraction. A pressure change occurs in the ink within the pressure chamber due to the deformation of the nozzle plate, and the ink within the nozzle is discharged.

A drive circuit which applies the driving waveform to the electrodes is formed on an electronic component such as an integrated circuit (IC). The electronic component, for example, is connected to the electrodes via a flexible printed circuit board or other wiring. When using a flexible printed circuit board, for example, the flexible printed circuit board is connected to a pad which is formed on the nozzle plate and it includes the piezoelectric actuator.

However, there is still room for improvement with respect to piezoelectric element ink jet heads having a low power consumption during discharging of the ink in a precise and low-cost manner.

### DESCRIPTION OF THE DRAWINGS

FIG. 1 is an exploded perspective view showing an ink jet head according to a first embodiment.

FIG. 2 is a plane view showing the ink jet head of the first embodiment.

FIG. 3 is a cross-sectional view along the F3-F3 line of FIG. 2 showing the ink jet head of the first embodiment.

FIG. 4 is a view schematically showing the configuration of a drive circuit of the first embodiment.

FIG. 5 is an enlarged cross-sectional view showing a portion of the ink jet head of the first embodiment.

FIG. 6 is a cross-sectional view showing the ink jet head of the manufacturing process of the first embodiment.

FIG. 7 is a plane view showing an ink jet head, according to a second embodiment.

FIG. 8 is a plane view showing an ink jet head, according to a third embodiment.

FIG. 9 is a cross-sectional view showing an ink jet head, according to a fourth embodiment.

FIG. 10 is an exploded perspective view showing an ink jet head according to a fifth embodiment.

FIG. 11 is a plan view showing the ink jet head of the fifth embodiment.

FIG. 12 is a cross-sectional view along the F12-F12 line of FIG. 11 showing the ink jet head of the fifth embodiment.

FIG. 13 is a cross-sectional view along the F13-F13 line of FIG. 11 showing the ink jet head of the fifth embodiment.

FIG. 14 is a cross-sectional view showing an ink jet head according to a sixth embodiment.

FIG. 15 is an exploded perspective view showing an ink jet head according to a seventh embodiment.

FIG. 16 is an exploded perspective view showing an ink jet head according to an eighth embodiment.

### DETAILED DESCRIPTION

An ink jet head according to an embodiment comprises a substrate including a mounting surface and a pressure chamber open to the mounting surface, and a vibration plate including a first surface fixed to the mounting surface of the substrate and covering the pressure chamber, and a second surface opposite the first surface. The ink jet head further comprises a first electrode formed on the second surface of the vibration plate, a piezoelectric body overlapping the first electrode, a second electrode overlapping the piezoelectric body, and a protective film provided on the second surface of the vibration plate and covering the first electrode, the piezoelectric body and the second electrode. The ink jet head further comprises a nozzle in communication with the pressure chamber, formed on at least one of the vibration plate and the protective film, and configured to discharge ink, and a drive circuit provided on the mounting surface of the substrate and configured to apply a drive voltage to the first electrode or the second electrode to deform the piezoelectric body and to change a volume of the pressure chamber.

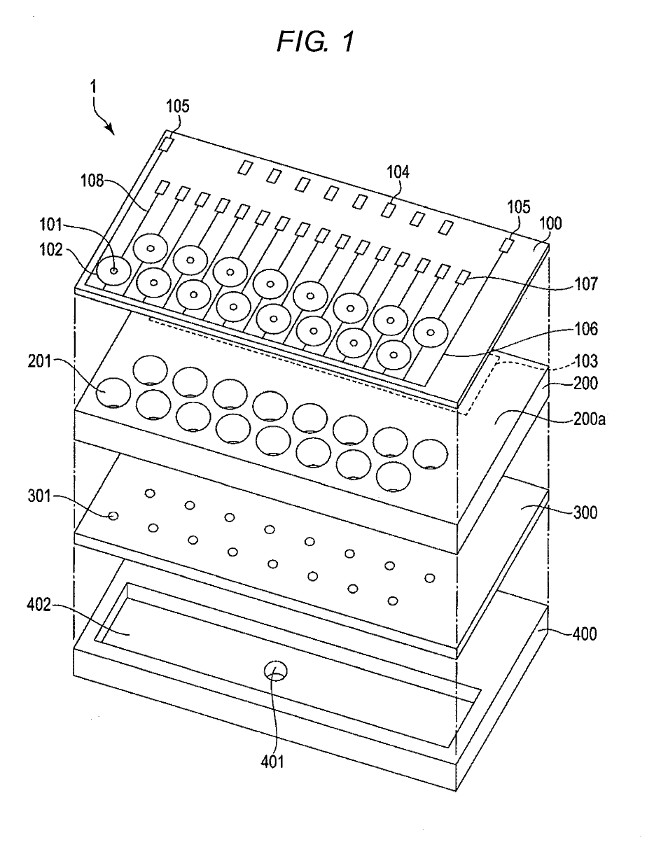

The first embodiment will be described below with reference to FIGS. 1 to 6.

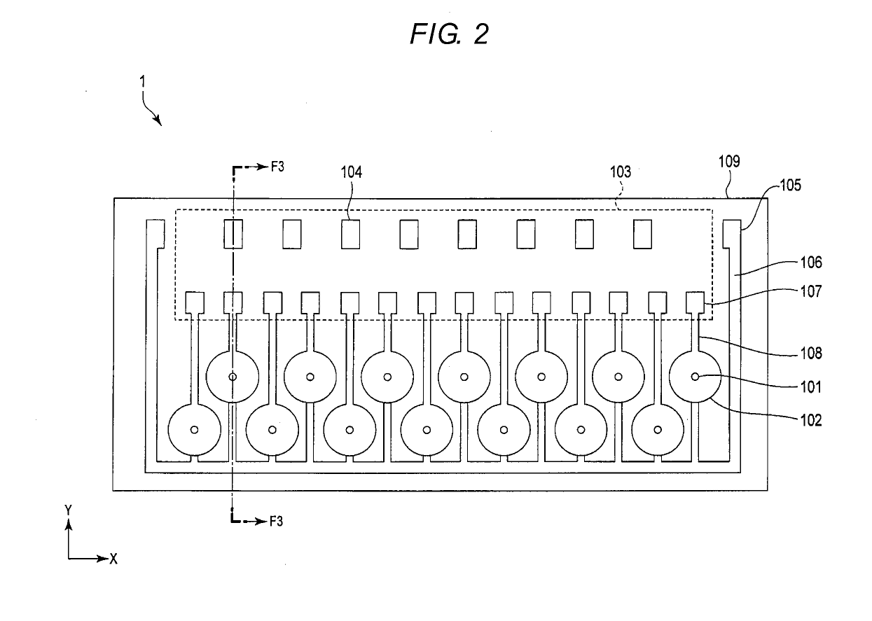

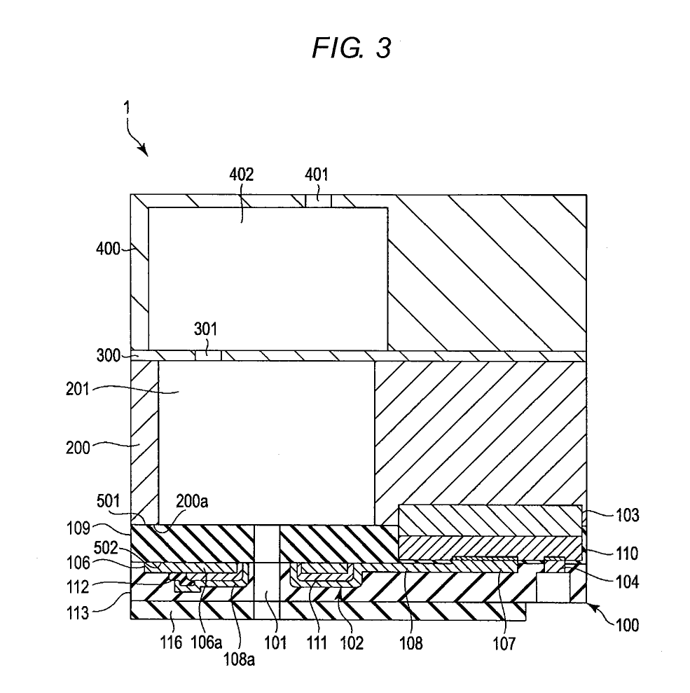

FIG. 1 is an exploded perspective view showing an ink jet head 1 according to the first embodiment. FIG. 2 is a plane view of the ink jet head 1 of the first embodiment. FIG. 3 is a cross-sectional view along the F3-F3 line of FIG. 2 schematically showing the ink jet head 1.

As shown in FIG. 1, the ink jet head 1 is mounted on the ink jet printer. The ink jet printer is an example of an image forming apparatus. The image forming apparatus is not limited thereto, and may be any other image forming apparatus such as a copy machine.

The ink jet head 1 includes a nozzle plate 100, a pressure chamber structure 200, a separate plate 300 and an ink feed passage structure 400. The pressure chamber structure 200 can be formed from a substrate. The pressure chamber structure 200, the separate plate 300 and the ink feed passage structure 400, for example, are joined with an epoxy-based adhesive.

The nozzle plate 100 is formed in a rectangular plate shape. The nozzle plate 100 is formed on the pressure chamber structure 200 using the film-forming process described below. As a result of the film-forming process, the nozzle plate 100 is adhered to the pressure chamber structure 200.

The nozzle plate 100 has a plurality of nozzles 101 for ink discharging. Each nozzle 101 is a circular hole which extends through the nozzle plate 100 in the thickness direction thereof. The diameter of the nozzle 101, for example, is 20 μm.

The pressure chamber structure 200 is formed from a silicon wafer and has a rectangular plate shape. The pressure chamber structure 200 is formed in the manufacturing process of the inkjet head 1 by repeatedly heating and forming a thin film. Therefore, the silicon wafer is heat resistant and is smoothened to conform to the Semiconductor Equipment and Materials International (SEMI) standard. Furthermore, the pressure chamber structure 200 is not limited thereto, and may also be formed from another semiconductor such as a silicon carbide (SiC) germanium substrate. The thickness of the pressure chamber structure 200, for example, is 525 μm.

The pressure chamber structure 200 has amounting surface 200a facing the nozzle plate 100, and a plurality of pressure chambers 201. The nozzle plate 100 is adhered to the mounting surface 200a.

The pressure chamber 201 is comprised of circular hole, i.e., a counterbored recess, but may also be formed in other shapes. The diameter of the pressure chamber 201, for example, is 240 μm. The pressure chamber 201 is open to the mounting surface 200a and is covered by the nozzle plate 100.

The plurality of pressure chambers 201 are arranged so as to correspond to the plurality of nozzles 101, and are disposed coaxially with the plurality of nozzles 101, respectively. Therefore, each pressure chamber 201 is in direct communication with a corresponding nozzle 101.

The separate plate 300 is formed in a rectangular plate shape from stainless steel. The thickness of the separate plate 300, for example, is 200 μm. The separate plate 300 covers the plurality of pressure chambers 201 on the side of the pressure chamber structure 200 opposite of the position of the nozzle plate 100.

The separate plate 300 has a plurality of ink apertures 301. The plurality of ink apertures 301 are respectively arranged to correspond to one of the pressure chambers 201. Therefore, each pressure chamber 201 is open to one of the ink apertures 301. The diameter of the ink aperture 301, for example, is 60 μm. The ink apertures 301 are formed such that the ink flow path resistance to each of the respective pressure chambers 201 is approximately the same. Incidentally the ink apertures 301 can be removed if the diameter or depth of the pressure chambers 201 is adequately designed. Even if the separation plate 300 having the ink apertures 301 is not built in the inkjet head 1, ink drops can be discharged from the inkjet head 1.

The ink feed passage structure 400 is formed in a rectangular plate shape from stainless steel. The thickness of the ink feed passage structure 400, for example, is 4 mm. The ink feed passage structure 400 includes an ink supply port 401 and an ink supply passage 402.

The ink supply port 401 is open to the center portion of the ink supply passage 402. The ink supply port 401 is connected to an ink tank, in which the ink which forms an image is stored. The ink tank 11 supplies the ink to the ink supply passage 402.

The ink supply passage 402 is formed at a depth of 2 mm into the surface of the ink feed passage structure 400, and extends outwardly beyond the perimeter of the array of ink apertures 301. In other words, each of the ink apertures 301 open into the ink supply passage 402. Therefore, the ink supply port 401 supplies the ink to all of the pressure chambers 201 via the ink apertures 301. In addition, the ink supply port 401 is formed such that the ink flow path resistance to each of the respective pressure chambers 201 is approximately the same.

As described above, the separate plate 300 and the ink feed passage structures 400 may be formed from stainless steel. However, the materials of such components are not limited to stainless steel. The separate plate 300 and the ink feed passage structure 400 may also be formed from another material such as ceramic, resin or metal alloy, so long as a difference in expansion coefficient between the separate plate 300 and the ink feed passage structure 400 on the one hand, and the nozzle plate 100, on the other hand does not affect the generation of ink discharge pressure. Examples of the ceramic that may be used include alumina ceramics, zirconia, silicon carbide, and nitrides and oxides such as silicon nitride and barium titanate. Examples of the resin that may be used include plastic materials such as acrylonitrile-butadiene-styrene (ABS), polyacetal, polyamide, polycarbonate and polyether sulfone. Examples of the metal that may be used include aluminum and titanium.

The pressure chamber 201 maintains a supply of ink therein drawn from the ink supply passage through the ink apertures 301. Furthermore, when a pressure change occurs in the ink within each of the pressure chambers 201 due to the deformation of the nozzle plate 100, the ink within the pressure chambers 201 is discharged from each of the nozzles 101. The separate plate 300 traps the pressure generated within the pressure chambers 201 and suppresses the escape of the pressure to the ink supply passage 402. Therefore, the diameter of the ink aperture 301 is ¼ or less of the diameter of the pressure chamber 201.

Furthermore, the ink feed passage structure 400 may also be formed so as to circulate the ink. In this case, the ink feed passage structure 400 has an ink ejection port in addition to the ink supply port 401. Accordingly, the ink is circulated within the ink supply passage 402.

By circulating the ink, the ink temperature within the ink supply passage 402 can be maintained at a fixed temperature. For such an ink jet head 1, the temperature rise of the ink jet head 1, caused by the heat generated by the deformation of the nozzle plate 100, is better suppressed in comparison with the ink jet head 1 of FIG. 1.

Next, description will be given of the nozzle plate 100 and a drive circuit 103. As shown in FIGS. 2 and 3, the nozzle plate 100 includes the plurality of nozzles 101, a plurality of actuators 102, a plurality of pad units 104, two shared electrode terminal portions 105, a shared electrode 106 extending between the shared electrode portions 105, a wiring electrode terminal portion 107, a plurality of wiring electrodes 108, a vibration plate (a CMOS passivation layer) 109, a protective film 113 and an ink-repellent film 116. The shared electrode 106 is an example of the first electrode. The wiring electrode 108 is an example of the second electrode.

The vibration plate 109 is formed in a rectangular plate shape on the mounting surface 200a of the pressure chamber structure 200. The thickness of the vibration plate 109, for example, is 2 μm. The thickness of the vibration plate 109 is approximately in the range of 1 μm to 50 μm.

The vibration plate 109 has a first surface 501 and a second surface 502. The first surface 501 is adhered to the mounting surface 200a of the pressure chamber structure 200 and covers the pressure chamber 201, except in the location of the nozzle 101 extending therethrough. The second surface 502 is positioned on side opposite to the first surface 501. The actuator 102, the shared electrode 106 and the wiring electrode 108 are formed on the second surface 502 of the vibration plate 109.

The plurality of actuators 102 are arranged so that each corresponds to one of the plurality of pressure chambers 201 and one of the plurality of nozzles 101. The actuator 102 generates the pressure which discharges the ink from the nozzle 101 in the pressure chamber 201.

As shown in FIG. 2, the actuator 102 is formed in a circular shape. The actuator 102 is arranged on the same axis as the corresponding nozzle 101. Therefore, the nozzle 101 is provided inside the envelope of, and extends through, the actuator 102.

In order to arrange the nozzles 101 at a higher density, the nozzles 101 are arranged in a zigzag shape. In other words, the plurality of nozzles 101 are arranged linearly in the X axis direction of FIG. 2. There are two aligned rows of the nozzles 101 in the Y axis direction. The distance between the centers of the adjacent nozzles 101 in the X axis direction, for example, is 340 μm. The arrangement interval of the two rows of the nozzles 101 in the Y axis direction, for example, is 240 μm.

As shown in FIG. 3, the actuator 102 includes a piezoelectric film 111, an electrode portion 106a of the shared electrode 106, an electrode portion 108a of the wiring electrode 108 and an insulating film 112. The piezoelectric film 111 is an example of the piezoelectric body.

The piezoelectric film 111 may be formed from lead zirconate titanate (PZT) in a film shape. Furthermore, the piezoelectric film 111 is not limited thereto, and for example, may also be formed from various materials such as PTO (PbTiO₃: lead titanate), PMNT (Pb(Mg_{1/3}Nb_{2/3})O₃—PbTiO₃) PZNT (Pb(Zn_{1/3}Nb_{2/3})O₃—PbTiO₃), ZnO and AlN.

The piezoelectric film 111 is formed in a circular shape. The piezoelectric film 111 is arranged about the same axis as the nozzle 101 and the pressure chamber 201. In other words, the piezoelectric film 111 surrounds the nozzle 101. The diameter of the piezoelectric film 111, for example, is 170 μm. The inner circumferential portion of the piezoelectric film 111 is separated slightly from the nozzle 101.

The thickness of the piezoelectric film 111, for example, is 1 μm. The thickness of the piezoelectric film is determined by the piezoelectric properties of the piezoelectric material, the breakdown voltage and the like. The thickness of the piezoelectric film is approximately in the range of from 0.1 μm to 5 μm.

The piezoelectric film 111 is sandwiched between the electrode portion 108a of the wiring electrode 108 and the electrode portion 106a of the shared electrode 106. In other words, the electrode portion 108a of the wiring electrode 108 and the electrode portion 106a of the shared electrode 106 are disposed on either side of the piezoelectric film 111.

The piezoelectric film 111 generates a polarity in the thickness direction. When an electric field of the same direction as the direction of the polarization is applied to the piezoelectric film 111 via the wiring electrode 108 and the shared electrode 106, the actuator 102 expands and contracts in the direction perpendicular to the electrical field direction. The vibration plate 109 deforms in the thickness direction of the nozzle plate 100 according to the expansion and contraction of the actuator 102. Accordingly, a pressure change occurs in the ink within the pressure chamber 201.

The operations of the piezoelectric film 111 contained in the actuator 102 will be described in more detail. The piezoelectric film 111 contracts or expands in a direction perpendicular to the film thickness (the direction within the surface). When the piezoelectric film 111 contracts, the vibration plate 109 to which the piezoelectric film 111 is bonded bends in the direction which expands the pressure chamber 201. The bending which expands the pressure chamber 201 generates a negative pressure in the ink stored within the pressure chamber 201. According to the generated negative pressure, the ink is supplied from the ink feed passage structure 400 to the inside of the pressure chamber 201. When the piezoelectric film 111 expands, the vibration plate 109 to which the piezoelectric film 111 is bonded bends in the direction of the pressure chamber 201. The bending toward the direction of the pressure chamber 201 of the vibration plate 109 generates a positive pressure in the ink stored within the pressure chamber 201. According to the generated positive pressure, ink droplets are discharged from the nozzle 101 provided in the vibration plate 109. During the expansion or the contraction of the pressure chamber 201, in the vicinity of the nozzle 101 the vibration plate 109 deforms in the direction in which the ink is discharged according to the deformation of the piezoelectric film 111. In other words, the actuator 102 which discharges the ink operates in a bending mode.

The electrode portion 108a of the wiring electrode 108 is one of the two electrodes joined to the opposed sides of the piezoelectric film 111. The electrode portion 108a of the wiring electrode 108 is formed with a larger annular shape than the piezoelectric film 111, and is formed as a film on the discharge side (the side facing the outside of the ink jet head 1) of the piezoelectric film 111. The outer diameter of the electrode portion 108a, for example, is 174 μm.

The electrode portion 106a of the shared electrode 106 is one of the two electrodes joined to the piezoelectric film 111. The electrode portion 106a of the shared electrode 106 is formed with a smaller annular shape than the piezoelectric film 111, and is formed as a film on the second surface 502 of the vibration plate 109. The electrode portion 106a of the shared electrode 106 is formed on the second surface 502 of the vibration plate 109. The outer diameter of the electrode portion 106a, for example, is 166 μm.

The insulating film 112 is interposed between the shared electrode 106 and the wiring electrode 108 outside of the region in which the piezoelectric film 111 is formed. In other words, between the shared electrode 106 and the wiring electrode 108 is insulated by the piezoelectric film 111 or the insulating film 112. The insulating film 112, for example, may be formed from SiO₂ (silicon oxide). The insulating film 112 may also be formed from another material. The thickness of the insulating film 112, for example, is 0.2 μm.

As shown in FIG. 3, the mounting surface 200a of the pressure chamber structure 200 is provided with the drive circuit 103. The drive circuit 103, for example, is a semiconductor integrated circuit which drives the ink jet head 1 and includes a logical circuit, a setting circuit and an analogue circuit. In addition, the vibration plate 109 is provided with an interconnection layer 110. The interconnection layer 110 is formed so as to connect the vibration plate 109 to the drive circuit 103. The drive circuit 103 and the interconnection layer 110 will be described below.

A pad unit 104 is connected to the interconnection layer 110. The pad unit 104 includes electrodes which provides the power supply connection, the ground connection and the input-output signal sending and receiving in relation to the drive circuit 103. The pad unit 104, for example, is connected to wiring which is connected to a control unit of an ink jet printer.

The wiring electrode terminal portion 107 is provided on the end portion of the wiring electrode 108, and is connected to the interconnection layer 110. The wiring electrode terminal portion 107 is connected to the output of an analogue circuit of the drive circuit 103, and transmits a signal which drives the actuator 102.

As shown in FIG. 2, the interval between each of the plurality of wiring electrode terminal portions 107 is the same as the interval in the X axis direction of the nozzle 101. The width in the X axis direction of the wiring electrode terminal portion 107 is wide in comparison with the width of the wiring electrode 108 in the x direction. Therefore, the wiring electrode terminal portion 107 is easily connected to the interconnection layer 110.

The shared electrode terminal portions 105, for example, are provided on the second surface 502 of the vibration plate 109. The shared electrode terminal portions 105 are the end portions of the shared electrode 106, and are connected to GND (ground=0V).

Each wiring electrode 108 is individually joined to a single piezoelectric film 111 of a corresponding actuator 102, and transmits a signal which drives the actuator 102. The wiring electrode 108 is used as an individual electrode which causes the piezoelectric film 111 to move independently of other piezoelectric films 111 on the nozzle plate 100. The plurality of wiring electrodes 108 each include the electrode portion 108a described above, the wiring portion and the wiring electrode terminal portion 107 described above.

The wiring portion of the wiring electrode 108 extends from the electrode portion 108a toward the wiring electrode terminal portion 107. The electrode portion 108a of the wiring electrode 108 is centered on the same axis as the nozzle 101. The inner circumferential portion of the electrode portion 108a is spaced slightly from the outer circumference of the nozzle 101.

The plurality of wiring electrodes 108 may be formed of, for example, a thin film of Pt (platinum). Furthermore, the wiring electrodes 108 may also be formed from another material such as Ni (nickel), Cu (copper), Al (aluminum), Ag (silver), Ti (titanium), W (tantalum), Mo (molybdenum) or Au (gold). The thickness of the wiring electrode 108, for example, is 0.5 μm. The film thickness of the plurality of wiring electrodes 108 is approximately 0.01 μm to 1 μm.

The shared electrode 106 is connected to the plurality of piezoelectric films 111. The shared electrode 106 includes the plurality of electrode portions 106a described above, a plurality of wiring portions and the two shared electrode terminal portions 105 described above.

The wiring portion of the shared electrode 106 extends from the electrode portion 106a to the side of the wiring portion opposite to that of the wiring electrode 108. The wiring portions of the shared electrode 106 join at the end portion of the nozzle plate 100 in the Y axis direction of the nozzle plate 100 as shown in FIG. 2, and extend to both end portions of the nozzle plate 100 in the X axis direction. The electrode portion 106a is provided coaxially around the same axis as the nozzle 101. The inner circumferential portion of the electrode portion 106a is spaced slightly from the outer circumference of nozzle 101. The shared electrode terminal portions 105 are respectively arranged at opposed ends in the X axis direction of the nozzle plate 100.

The shared electrode 106 may be formed from a Pt (platinum)/Ti (titanium) thin film. The shared electrode 106 may also be formed from another material such as Ni, Cu, Al, Ti, W, Mo or Au. The thickness of the shared electrode 106, for example, is 0.5 μm. The thickness of the shared electrode 106 is approximately from 0.01 μm to 1 μm.

The width of each of the wiring portions of the wiring electrode 108 and the shared electrode 106, for example, is Several of the wiring electrodes 108 and the shared electrode 106 are wired so as to pass between the row of actuators 102.

As shown in FIG. 3, the protective film 113 is provided on the second surface 502 of the vibration plate 109 and the protective film 113 covers the second surface 502 of the vibration plate 109, the shared electrode 106, the wiring electrode 108 and the piezoelectric film 111.

The protective film 113 may be formed from a polyimide. The protective film 113 is not limited thereto, and may also be formed from another material such as a resin, a ceramic or a metal (an alloy). Examples of a resin used include plastic materials such as acrylonitrile-butadiene-styrene (ABS), polyacetal, polyamide, polycarbonate and polyether sulfone. Examples of the ceramic used include zirconia, silicon carbide, and nitrides and oxides such as silicon nitride and barium titanate. Examples of the metal used include aluminum, SUS and titanium.

The Young's modulus of the material of the protective film 113 differs greatly from the Young's modulus of the material of the vibration plate 109. The deformation amount of the plate shape is influenced by the Young's modulus and the plate thickness of the material. Even when the same force is applied, the smaller the Young's modulus and the thinner the plate thickness, the greater the deformation becomes. The Young's modulus of SiO₂ which forms the vibration plate 109 is 80.6 GPa, and the Young's modulus of the polyimide which forms the protective film 113 is 4 GPa. In other words, the difference between the Young's modulus of the vibration plate 109 and the protective film 113 is 76.6 GPa.

The thickness of the protective film 113, for example, is 3 μm. The thickness range of the protective film 113 is approximately in the range of 1 μm to 50 μm. The ink-repellent film 116 covers the surface of the protective film 113. The ink-repellent film 116 is formed from a silicone-based liquid repellent material which has liquid repelling properties. Furthermore, the ink-repellent film 116 may also be formed from another material such as an organic material which contains fluorine. The thickness of the ink-repellent film 116, for example, is 1 μm.

The ink-repellent film 116 does not cover the pad unit 104 and the protective film 113 at the periphery of the pad unit 104, which are thereby exposed. The nozzle 101 extends through the vibration plate 109, the protective film 113 and the ink-repellent film 116.

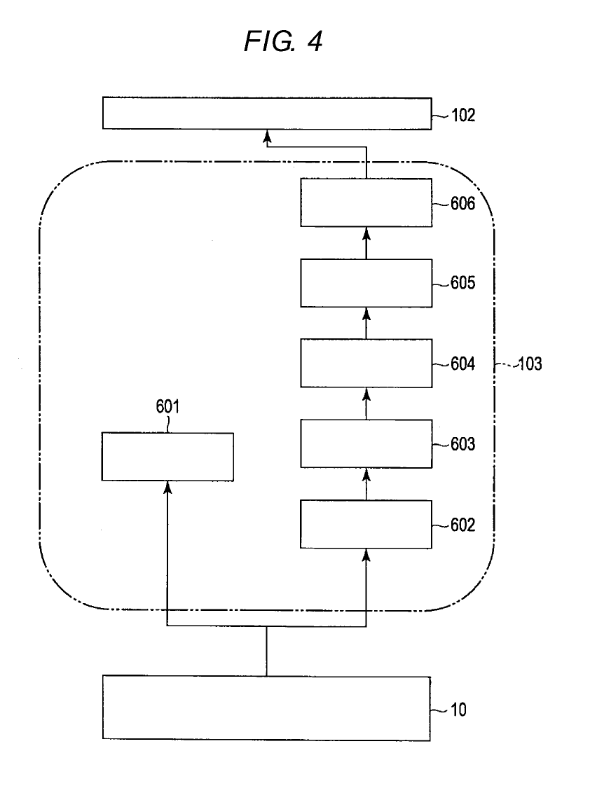

FIG. 4 is a view schematically showing the configuration of the drive circuit 103. As shown in FIG. 4, the drive circuit 103 includes a setting circuit 601, a shift register 602, a latch & dividing distributor 603, a switch control 604, a level shift circuit 605 and an output circuit 606.

The setting circuit 601 and the shift resistor 602 are connected to an external circuit 10. The external circuit 10, for example, is a control unit of the ink jet head, and outputs an electrical signal corresponding to an operation of a user or a program set in advance. The output circuit 606 is connected to the actuator 102 via the wiring electrode 108.

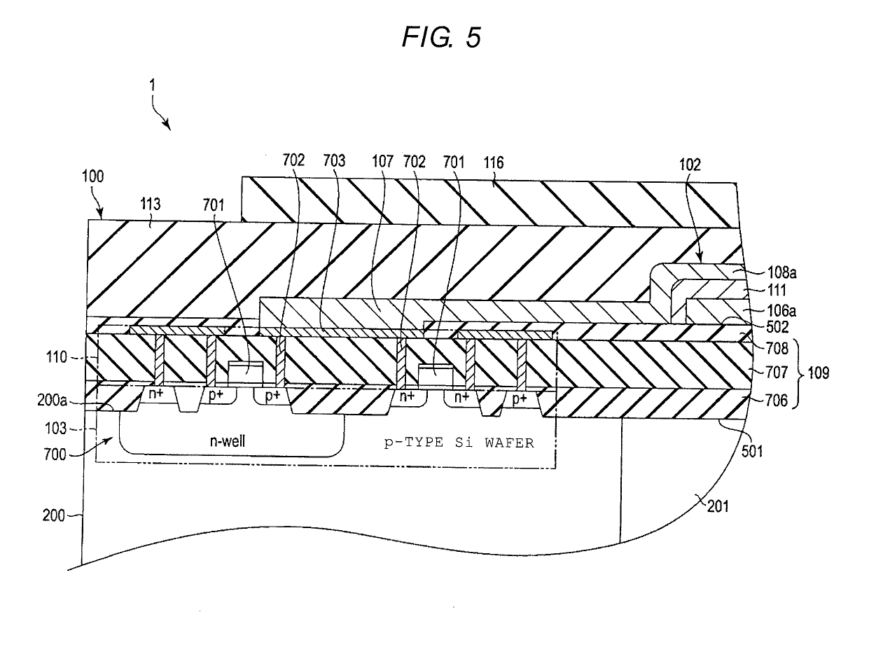

FIG. 5 is a cross-sectional view of the ink jet head 1, showing an enlarged view of the periphery of the drive circuit 103. Furthermore, in FIG. 5, the hatching of the pressure chamber structure 200 is omitted for the purpose of illustration.

As shown in FIG. 5, the drive circuit 103 includes a CMOS transistor 700. The CMOS transistor 700 shown in FIG. 5 is included in the output circuit 606. The drive circuit 103 includes a plurality of other CMOS transistors and wiring patterns. In addition, the drive circuit 103, for example, may also include another semiconductor device such as a MESFET transistor.

The CMOS transistor 700 is formed directly on the mounting surface 200a of the pressure chamber structure 200 which is formed from a silicon wafer. In other words, the CMOS transistor 700 is created by subjecting the pressure chamber structure 200 formed from the p-type silicon wafer to, for example, various processes including ion implantation. The CMOS transistor 700 is connected to the level shift circuit 605 through a gate 701.

The CMOS transistor 700 is connected to a drain 703 via a plug 702. The drain 703 is connected to the wiring electrode terminal portion 107. Accordingly, the CMOS transistor 700 is connected to the actuator 102 via the wiring electrode 108.

As shown in FIG. 5, the vibration plate 109 includes a first layer 706, a second layer 707 and a third layer 708. The first to the third layers 706 to 708 are formed from SiO₂. Furthermore, the first to the third layers 706 to 708 are not limited thereto, and may also be formed from SiN (silicon nitride), Al₂O₃ (aluminum oxide), HfO₂ (hafnium oxide) or Diamond Like Carbon (DLC). In the selection of the material of the vibration plate 109, for example, the heat resistance, the insulation properties (the influence of the ink deterioration caused by the driving of the actuator 102 when using an ink having high conductivity), the thermal expansion coefficient, the smoothness and the wettability in relation to ink are considered. In addition, each of the materials of the first to the third layers 706 to 708 may be different.

The first layer 706 is in contact with the mounting surface 200a of the pressure chamber structure 200. The first layer 706 extends in the gap between a plurality of projecting portions which form the CMOS transistor 700, and the gap between the CMOS transistor 700 and another CMOS transistor. In other words, the first layer 706 separates the plurality of semiconductor devices from each other. The first layer 706 is a so-called element isolator.

The second layer 707 is laminated on the first layer 706 and covers the gate 701. The second layer 707 is also interposed between the CMOS transistor 700 and the drain 703. The second layer 707 is a so-called interlayer insulating film. The plug 702 penetrates the first and the second layers 706 and 707.

The third layer 708 is laminated on the second layer 707 and covers the p channel drain or the n channel drain which is connected to the CMOS transistor 700. In other words, the third layer 708 covers the drive circuit 103. The third layer 708 is a so-called passivation layer. Furthermore, since the first to the third layers 706 to 708 are insulating films which cover and protect the CMOS transistor 700, the vibration plate 109 may be referred to as a passivation layer. The drain 703 is exposed in the third layer 708.

In FIG. 5, the drive circuit 103 and the interconnection layer 110 are shown using a two-dot chain line. In other words, the portion containing the CMOS transistor 700 and the plurality of other CMOS transistors is shown as the drive circuit 103, and the portion containing the drain 703 which connects the CMOS transistor 700 and the wiring electrode 108 is shown as the interconnection layer 110. However, the drive circuit 103 and the interconnection layer 110 in FIG. 5 are shown for the purpose of illustration and are respectively not strictly defined. The drive circuit 103 contains the CMOS transistor 700, and is a circuit which outputs a signal which drives the actuator 102. The interconnection layer 110 is a portion interposed between the drive circuit 103 and the wiring electrode terminal portion 107.

The ink jet head 1 described above prints (forms an image) in the following manner. The ink is supplied from the ink tank of the ink jet printer to the ink supply port 401 of the ink feed passage structure 400. The ink passes through the ink aperture 301 and is supplied to the pressure chamber 201. The ink supplied to the pressure chamber 201 is supplied to the inside of the corresponding nozzle 101 and forms a meniscus within the nozzle 101. The ink supplied from the ink supply port 401 is held with an appropriate negative pressure, and the ink within the nozzle 101 is maintained without leaking from the nozzle 101.

For example, the external circuit 10 inputs a printing command signal to the drive circuit 103 according to the operation of a user. The drive circuit 103 which receives the printing command outputs a signal to the actuator 102 via the wiring electrode 108. In other words, the drive circuit 103 applies a voltage to the electrode portion 108a of the wiring electrode 108. Accordingly, an electric field of the same direction as the polarization direction is applied to the piezoelectric film 111, and the actuator 102 expands and contracts in a direction perpendicular to the electric field direction.

The actuator 102 is sandwiched between the vibration plate 109 and the protective film 113. Therefore, when the actuator 102 expands in a direction perpendicular to the electrical field direction, a force which deforms in a concave shape in relation to the pressure chamber 201 side is applied to the vibration plate 109. Furthermore, a force which deforms in a convex shape in relation to the pressure chamber 201 side is applied to the protective film 113. When the actuator 102 contracts in a direction perpendicular to the electrical field direction, a force which deforms in a convex shape in relation to the pressure chamber 201 side is applied to the vibration plate 109. In addition, a force which deforms in a concave shape in relation to the pressure chamber 201 side is applied to the protective film 113.

The polyimide film of the protective film 113 has a smaller Young's modulus than the SiO₂ film of the vibration plate 109. Therefore, the deformation amount of the protective film 113 is greater in relation to the same force. When the actuator 102 expands in a direction perpendicular to the electrical field direction, the nozzle plate 100 deforms in a convex shape in relation to the pressure chamber 201 side. Accordingly, the volume of the pressure chamber 201 contracts, because the amount by which the protective film 113 deforms in a convex shape is greater than the deformation on the pressure chamber 201 side. Conversely, when the actuator 102 contracts in a direction perpendicular to the electrical field direction, the nozzle plate 100 deforms in a concave shape in relation to the pressure chamber 201 side. Accordingly, the volume of the pressure chamber 201 expands, because the amount by which the protective film 113 deforms in a concave shape is greater than the deformation on the pressure chamber 201 side.

When the vibration plate 109 deforms and the volume of the pressure chamber 201 increases and decreases, a pressure change occurs in the ink of the pressure chamber 201. The ink supplied to the nozzle 101 is discharged according to the pressure change.

The greater the difference between the Young's modulus of the vibration plate 109 and the protective film 113, the greater the difference between the deformation amount of the vibration plate 109 and the protective film 113 when the same voltage is applied to the actuator 102. Therefore, the greater the difference between the Young's modulus of the vibration plate 109 and the protective film 113, the lower a voltage is necessary to make the discharging of ink possible.

When the film thickness and the Young's modulus of the vibration plate 109 and the protective film 113 are the same, the vibration plate 109 does not deform, since even if a voltage is applied to the actuator 102, the same amount of deforming force is applied in opposite directions in the vibration plate 109 and the protective film 113.

Furthermore, as described above, the deformation amount of the plate material is influenced not only by the Young's modulus of the material, but also by the plate thickness. Therefore, when determining the difference of the deformation amounts of the vibration plate 109 and the protective film 113, the respective film thicknesses are considered in addition to the Young's modulus of the material. Even if the Young's modulus of the materials of the vibration plate 109 and the protective film 113 are similar or the same, the ink can be discharged if there is a difference in the film thickness, but the required voltage to discharge the same volume of ink is higher.

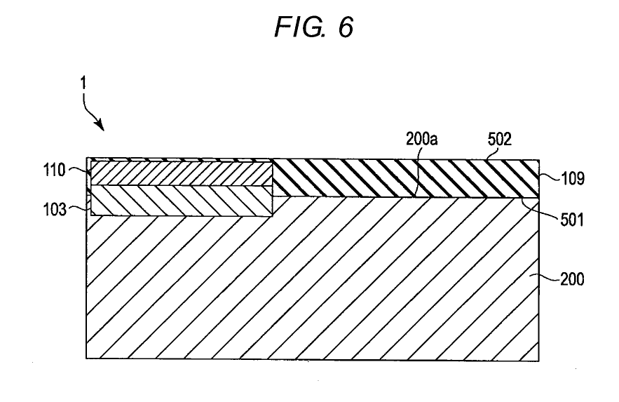

Next, a description will be given of an example of the manufacturing method of the ink jet head 1. FIG. 6 shows the inkjet head 1 in the manufacturing process. As shown in FIG. 6, the drive circuit 103 is formed on the pressure chamber structure 200 (the silicon wafer) prior to the formation of the pressure chamber 201. The drive circuit 103, as described above, is created by subjecting the pressure chamber structure 200 to, for example, various processes including ion implantation.

The SiO₂ film which forms the vibration plate 109 is formed as a film on the entire region of the attachment portion 200a of the pressure chamber structure 200 using the CVD method. The first to the third layers 706 to 708 of the vibration plate 109 are formed in the processes of manufacturing the drive circuit 103. In the process, the gate 701, the plug 702 and the drain 703 are also formed.

Next, the nozzle 101 is formed by patterning the SiO₂ film of the vibration plate 109. In addition, the portion in which the pad unit 104 and the wiring electrode terminal portion 107 are provided is patterned. The patterning is performed by creating an etching mask on a SiO₂ film and removing unmasked portions of the SiO₂ film using etching.

Next, the shared electrode 106 is formed as a film on the second surface 502 of the vibration plate 109. First, films of Ti and Pt are formed in order using the sputtering method. The film thickness of the Ti, for example, is 0.45 μm, and the film thickness of the Pt, for example, is 0.05 μm. Furthermore, the shared electrode 106 may also be formed using another manufacturing method such as deposition or gilding.

After forming the shared electrode 106 as a film, the plurality of electrode portions 106a, the wiring portion and the two shared electrode terminal portions 105 are formed using patterning. The patterning is performed by creating an etching mask on an electrode film and removing the unmasked portions of the electrode material using etching.

Since the nozzle 101 is formed on the center of the electrode portion 106a of the shared electrode 106, a portion is formed which does not have the electrode film which is concentric to the center of the electrode portion 106a and has a diameter of 34 μm. By patterning the shared electrode 106, the vibration plate 109 is exposed except for the electrode portion 106a of the shared electrode 106, the wiring portion and the shared electrode terminal portions 105.

Next, the piezoelectric film 111 is formed on the shared electrode 106. The piezoelectric film 111, for example, is formed as a film at a substrate temperature of 350° C. using the RF magnetron sputtering method. After the film formation, in order to apply piezoelectricity to the piezoelectric film 111, the piezoelectric film 111 is heated for three hours at 500° C. Accordingly, the piezoelectric film 111 obtains a favorable piezoelectric performance. The piezoelectric film 111, for example, may also be formed using another manufacturing method such as chemical vapor deposition (CVD), the sol-gel method, the aerosol deposition method (AD method) or the hydrothermal synthesis method. The piezoelectric film 111 is patterned using etching.

Since the nozzle 101 is formed in the center of the piezoelectric film 111, a portion is formed which does not have the piezoelectric film which is concentric to the piezoelectric film 111 and has a diameter of 30 μm. In the portion without the piezoelectric film 111, the vibration plate 109 is exposed. The diameter of the portion without the piezoelectric film 111 is 30 μm. The piezoelectric film 111 covers the electrode portion 106a of the shared electrode 106.

Next, the insulating film 112 is formed on a portion of the piezoelectric film 111 and a portion of the shared electrode 106. The insulating film 112 is formed using the CVD method, which is capable of realizing low temperature film formation with favorable insulative properties. The insulating film 112 is patterned after the film formation. The insulating film 112 covers a portion of the piezoelectric film 111 in order to suppress the problems caused by inconsistencies in the patterning. The insulating film 112 covers the piezoelectric film 111 to an extent which does not inhibit the deformation amount of the piezoelectric film 111.

Next, the wiring electrodes 108 are formed on the vibration plate 109, the piezoelectric film 111 and the insulating film 112. The wiring electrodes 108 may be formed as a film using the sputtering method. The wiring electrode 108 may also be formed using another manufacturing method such as vacuum deposition or gilding.

The electrode portion 108a, the wiring portion and the wiring electrode terminal portion 107 are formed by patterning the wiring electrodes 108 which are formed as a film. In addition, the pad unit 104 is formed by patterning the electrode film which forms the wiring electrodes 108. The patterning is performed by creating an etching mask on an electrode film and removing the unmasked electrode material using etching.

Since the nozzle 101 is formed on the center of the electrode portion 108a of the wiring electrode 108, a portion is formed which does not have the electrode film which is concentric to the center of the electrode portion 108a of the wiring electrode 108 and has a diameter of 26 μm. The electrode portion 108a of the wiring electrode 108 covers the piezoelectric film 111.

Next, the protective film 113 is formed as a film on the vibration plate 109, the wiring electrodes 108, the shared electrode 106 and the insulating film 112. The protective film 113 may be formed by forming a film of a solution containing a polyimide precursor using the spin-coating method, and subsequently performing thermal polymerization and solvent removal by baking the film. By forming the film using the spin-coating method, a film with a smooth surface is formed. The protective film 113, for example, may also be formed using another method such as CVD, vacuum deposition or plating or spin on methods.

Next, the pad unit 104 is exposed and the nozzle 101 is opened using patterning. When a non-photosensitive polyimide is used for the protective film 113, the patterning is performed by creating an etching mask on a non-photosensitive polyimide film and removing the polyimide film exposed outside of the etching mask using etching.

Next, a protective film cover tape is adhered onto the protective film 113. The pressure chamber structure 200 onto which the protective film cover tape is adhered is inverted vertically, and the plurality of pressure chambers 201 are formed in the pressure chamber structure 200.

The pressure chamber 201 is formed using patterning. First, the protective film cover tape is adhered onto the protective film 113. The protective film cover tape is, for example, a rear surface protective tape for chemical mechanical polishing (CMP) of a silicon wafer.

An etching mask is created on the pressure chamber structure 200, which is a silicon wafer, and the unmasked portions of the silicon wafer are removed using so-called vertical deep trench dry etching, which is specialized for silicon substrates. Accordingly, the pressure chamber 201 is formed.

The SF6 gas used in the etching described above does not exhibit an etching effect in relation to the SiO₂ film of the vibration plate 109 and the polyimide film of the protective film 113. Therefore, the progress of the dry etching of the silicon wafer which forms the pressure chamber 201 stops at the vibration plate 109.

Furthermore, for the etching described above, various other methods may be used, such as a wet etching method which uses chemicals or a dry etching method which uses plasma. etching method and the etching conditions may be changed in accordance with the materials of the insulating film, the electrode film, the piezoelectric film and the like. After the etching of each of the photosensitive resist films is completed, the remaining photosensitive resist films are removed using a solution.

Next, the separate plate 300 and the ink feed passage structure 400 are adhered to the pressure chamber structure 200. In other words, the separate plate 300 to which the ink feed passage structure 400 is secured to the pressure chamber structure 200 using an epoxy resin.

Next, a pad unit cover tape is adhered onto the protective film 113 so as to cover the pad unit 104 and the shared electrode terminal portions 105. The pad unit cover tape is formed from a resin, and is easily removed from and attached to the protective film 113. The pad unit cover tape 115 prevents the adhesion of dirt to the pad unit 104 and the shared electrode terminal portions 105, and prevents the adhesion of the ink-repellent film 116 described below.

Next, the ink-repellent film 116 is formed on the protective film 113. The ink-repellent film 116 is formed as a film by spin coating a liquid ink-repellent film material onto the protective film 113. Here, air of a positive pressure is injected through the ink supply port 401. Accordingly, the air is ejected from the nozzle 101 which is joined to the ink supply passage 402. When the liquid ink-repellent film material is coated under these conditions, adherence of the ink-repellent film material to the nozzle 101 inner wall is suppressed.

After the ink-repellent film 116 is formed, the pad unit cover tape is removed by peeling from the protective film 113. Accordingly, the ink jet head 1 shown in FIG. 3 is formed. The ink jet head 1 is installed in the inside of the ink jet printer, and the pad unit 104 is connected to the wiring.

The protective film 113 and the ink-repellent film 116 are etched in the region on which the pad unit 104 and the shared electrode terminal portions 105 are formed. Therefore, the pad unit 104 and the shared electrode terminal portions 105 are exposed. The ink-repellent film 116 and protective film 113 and are formed as films on the wiring electrode 108, outside of the region on which the pad unit 104 and the shared electrode terminal portions 105 are formed.

According to the ink jet head 1 of the first embodiment, the drive circuit 103 is provided on the mounting surface 200a of the pressure chamber structure 200 to which the vibration plate 109 is fixed. Accordingly, the distance between the drive circuit 103 and the actuator 102 can be shortened, and the wiring resistance can be reduced. Therefore, the attenuation of a signal emitted from the drive circuit 103 and the power consumption during the ink discharging can be reduced. In addition, even if the drive circuit 103 is provided on the pressure chamber structure 200, the protective film 113 and the ink-repellent film 116 facing a medium such as recording paper can be formed in a planar manner. Therefore, the distance between the medium and the nozzle 101 can be shortened, and the ink discharge precision can be maintained.

The CMOS transistor 700 of the drive circuit 103 is formed directly on the pressure chamber structure 200 which is formed from a silicon wafer. Accordingly, a semiconductor substrate other than the pressure chamber structure 200 need not be prepared, and the manufacturing cost of the inkjet head 1 can be reduced.

The vibration plate 109 covers the drive circuit 103. In other words, the vibration plate 109 is used as the passivation layer of the drive circuit 103. Accordingly, a passivation layer need not be formed separately, and an increase in the manufacturing processes and the material costs of the ink jet head 1 can be suppressed.

The vibration plate 109 separates the CMOS transistor 700 from the other CMOS transistors. In other words, the vibration plate 109 is used as an interlayer insulating film and an element isolator. Accordingly, an interlayer insulating film and an element isolator need not be formed separately, and an increase in the manufacturing processes and the material costs of the ink jet head 1 can be suppressed.

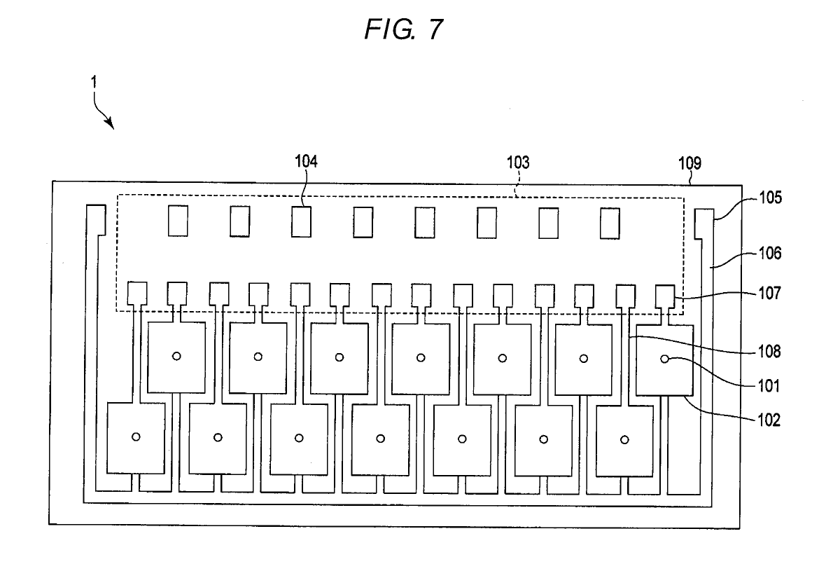

Next, description will be given of the second embodiment with reference to FIG. 7. Furthermore, in at least one of the embodiments disclosed below, components having the same function as in the ink jet head 1 of the first embodiment are assigned the same reference numerals. Furthermore, a portion of, or all of the description of such components may be omitted.

FIG. 7 is a plane view showing the ink jet head 1 according to the second embodiment. The actuator 102 of the second embodiment has a different shape to the actuator 102 of the first embodiment.

The actuator 102 of the second embodiment is formed in a rectangular shape. The width of the actuator 102, for example, is 170 μm. The length of the actuator 102, for example, is 340 μm. The nozzle 101 is arranged on the center of the actuator 102. The pressure chamber 201 is also formed in a rectangular shape, corresponding to the shape of the piezoelectric film 111.

The actuator 102 of the second embodiment is larger than the circular actuator 102 of the first embodiment. Accordingly, the ink discharging pressure of the ink jet head 1 can also be increased.

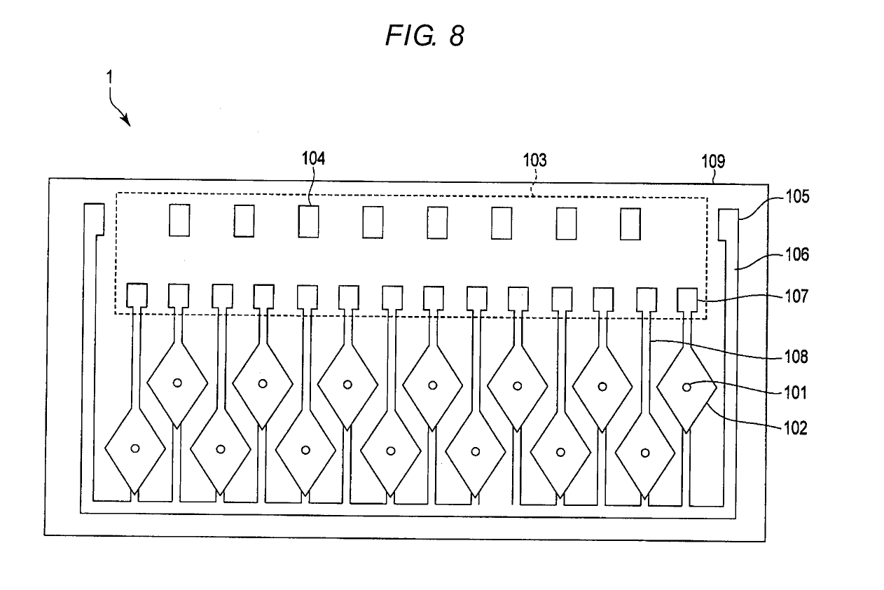

Next, description will be given of the third embodiment with reference to FIG. 8. FIG. 8 is a plane view showing the ink jet head 1 according to the third embodiment. The actuator 102 of the third embodiment has a different shape to the actuator 102 of the first embodiment.

The actuator 102 of the third embodiment is formed in a rhombic shape. The width of the actuator 102, for example, is 170 μm. The length of the actuator 102, for example, is 340 μm. The nozzle 101 is arranged on the center of the actuator 102. The pressure chamber 201 is also formed in a rhombic shape, corresponding to the shape of the actuator 102.

The actuator 102 of the third embodiment can be arranged with higher precision than the circular actuator 102 of the first embodiment. In other words, by forming the actuator 102 in a rhombic shape, the actuator 102 is easier to arrange in a zigzag shape.

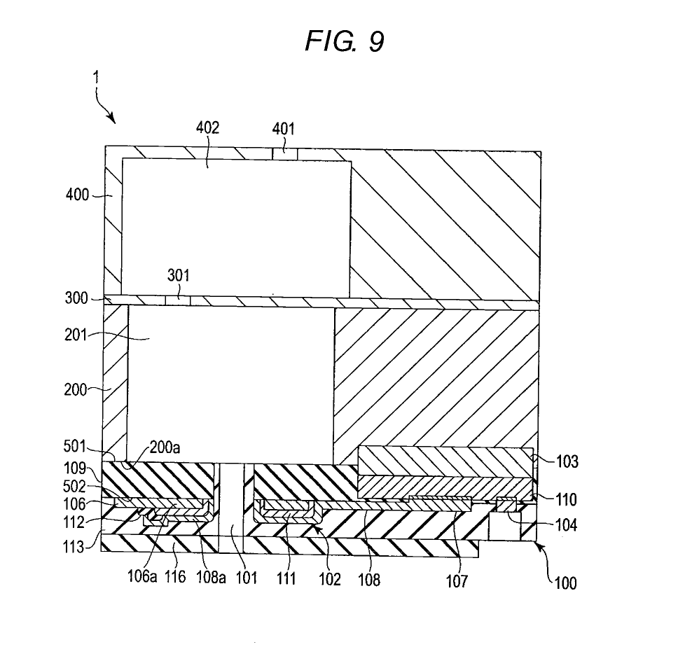

Next, description will be given of the fourth embodiment with reference to FIG. 9. FIG. 9 is a cross-sectional view showing the inkjet head 1 according to the fourth embodiment. The nozzle 101 of the first embodiment is formed in part in direct contact with the vibration plate 109 and the protective film 113. However, the nozzle 101 of the fourth embodiment is formed in the protective film 113, which in part extends through an aperture in the vibration, and not directly through the vibration plate 109.

As shown in FIG. 9, the vibration plate 109 has an opening portion 118. The diameter of the opening portion 118, for example, is 26 μm. The diameter of the opening portion 118 is greater than the diameter of the nozzle 101. The inner wall of the opening portion 118 is covered by a portion of the protective film 113 extending therein. In other words, the nozzle 101 is formed along the surface of protective film 113 in the opening portion 118.

According to the ink jet head 1 of the fourth embodiment, the nozzle 101 is formed on the protective film 113 and not the vibration plate 109. Accordingly, irregularity of the shape of the nozzles 101 can be suppressed. In other words, irregularity of the shape and the position can be prevented from occurring in a portion of the nozzles 101 provided on the vibration plate 109 and a portion of the nozzles 101 provided on the protective film 113. Therefore, the uniformity of the shape of the nozzles 101 and the precision of the landing position of the ink droplets between the plurality of nozzles 101 are improved.

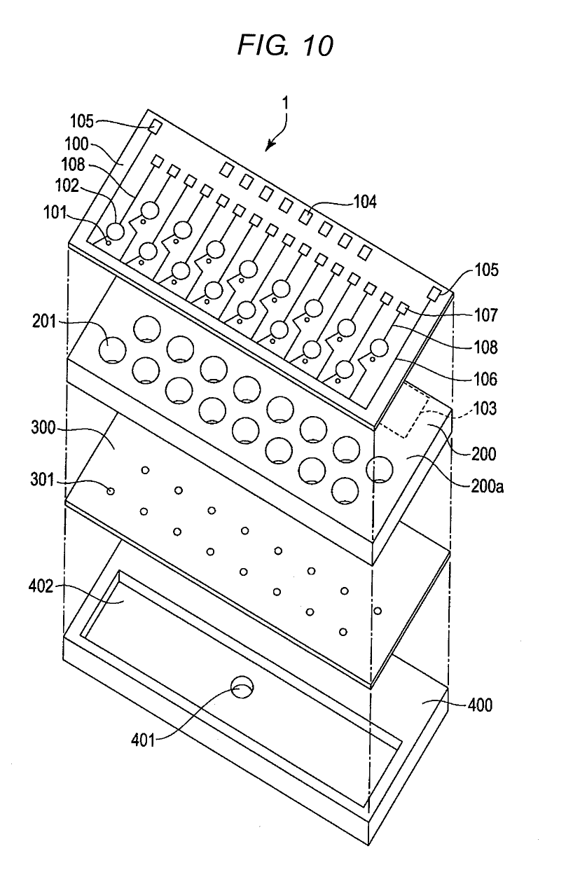

Next, description will be given of the fifth embodiment with reference to FIGS. 10 to 13. FIG. 10 is an exploded perspective view showing the ink jet head 1 according to the fifth embodiment. Unlike in the first embodiment, the nozzle 101 of the fifth embodiment is arranged outside of the perimeter of the actuator 102.

The center of the nozzle 101 corresponding to the pressure chamber 201 is present in a position separated from the center of the circular cross-section of the pressure chamber 201. The perimeter of the pressure chamber 201 surrounds the position of the corresponding actuator 102 and nozzle 101.

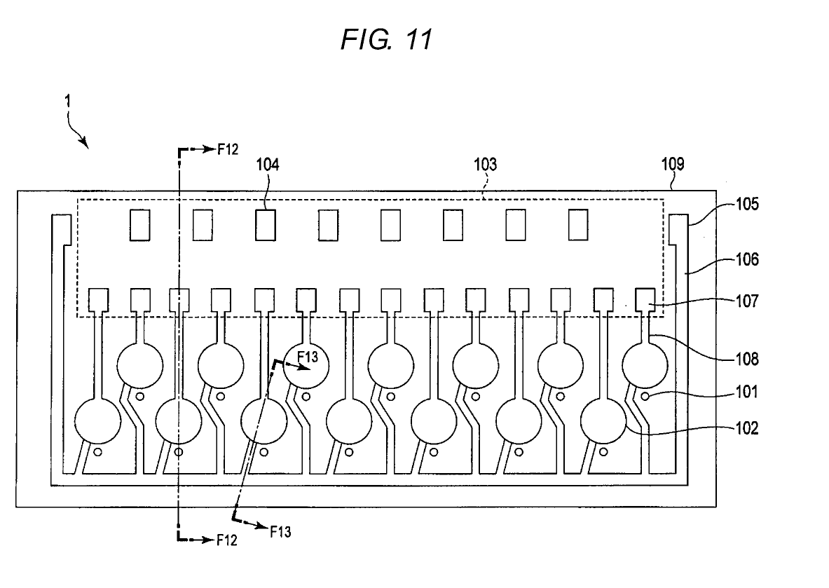

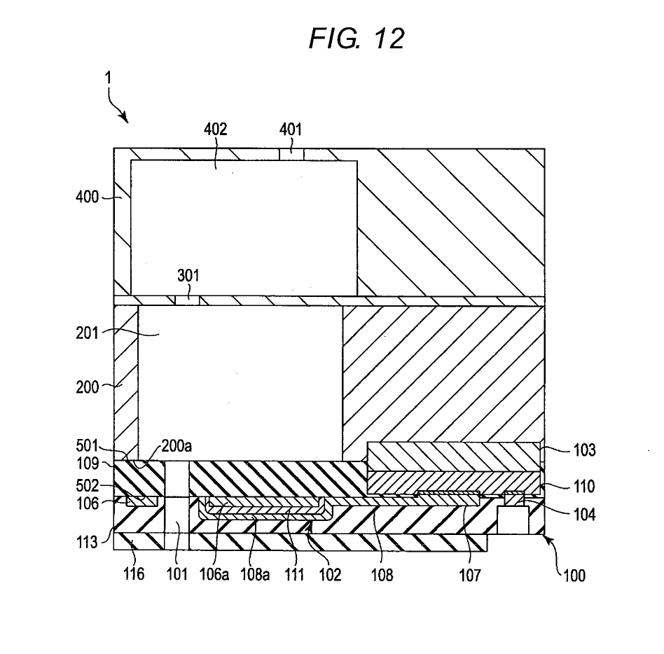

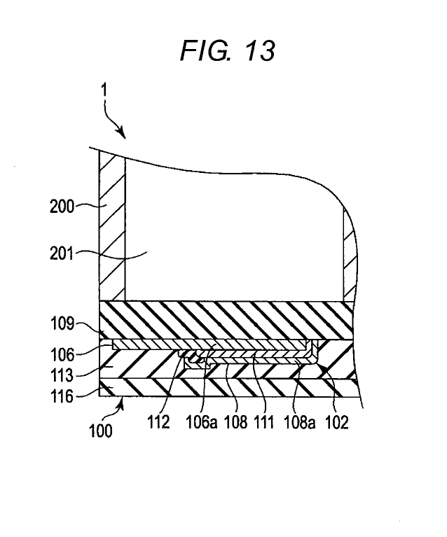

FIG. 11 is a plane view of the inkjet head 1 of the fifth embodiment. FIG. 12 is a cross-sectional view along the F12-F12 line of FIG. 11 showing the ink jet head 1. FIG. 13 is a cross-sectional view along the F13-F13 line of FIG. 11 showing the ink jet head 1.

The actuator 102 is formed in a circular shape, and is arranged in a different position to the corresponding nozzle 101. The diameter of the actuator 102, for example, is 170 μm. The center of the actuator 102 is present in a location separated from the center of the circular cross-section of the pressure chamber 201, but it overlies the pressure chamber 201 over the entire span thereof. Furthermore, the actuator 102 may also be arranged on the same axis as the pressure chamber 201.

According to the ink jet head 1 of the fifth embodiment, the nozzle 101 is arranged in a different position than the position of the actuator 102, i.e., it is offset therefrom. Therefore, the circular patterning for forming the nozzle on the center of the shared electrode 106 of the actuator 102, the piezoelectric film 111 and the wiring electrode 108 is no longer necessary. Accordingly, poor precision of the ink discharging position caused by poor patterning of these features by etching can be suppressed.

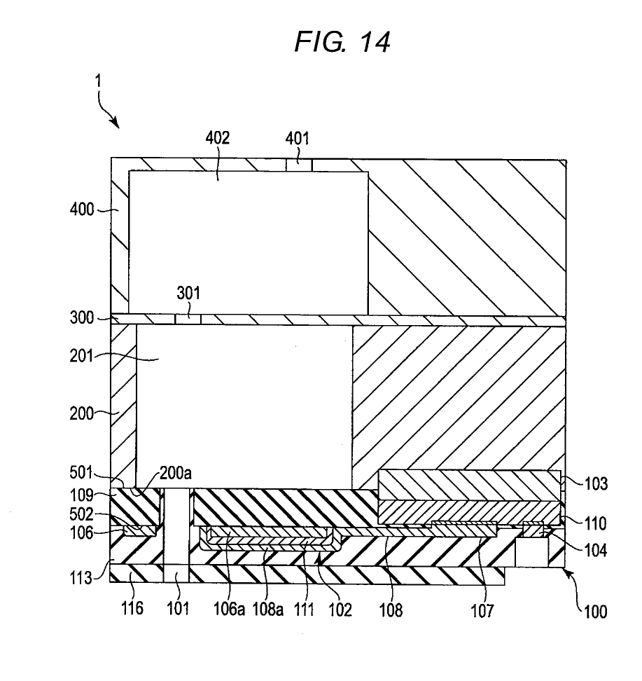

Next, description will be given of the sixth embodiment with reference to FIG. 14. FIG. 14 is a cross-sectional view showing the ink jet head 1 according to the sixth embodiment. As shown in FIG. 14, the nozzle 101 of the sixth embodiment is formed on a portion of the protective film 113 extending through an aperture in the vibration plate, and not directly through the vibration plate 109. Furthermore, in the same manner as the fifth embodiment, the nozzle 101 is arranged in a different position to the actuator 102.

In the same manner as the fourth embodiment, the precision of the landing position of the ink droplets between the plurality of nozzles 101 can be improved in the ink jet head 1 of the sixth embodiment. In addition, in the same manner as the fifth embodiment, poor precision of the ink discharging position caused by poor patterning can be suppressed in the ink jet head 1.

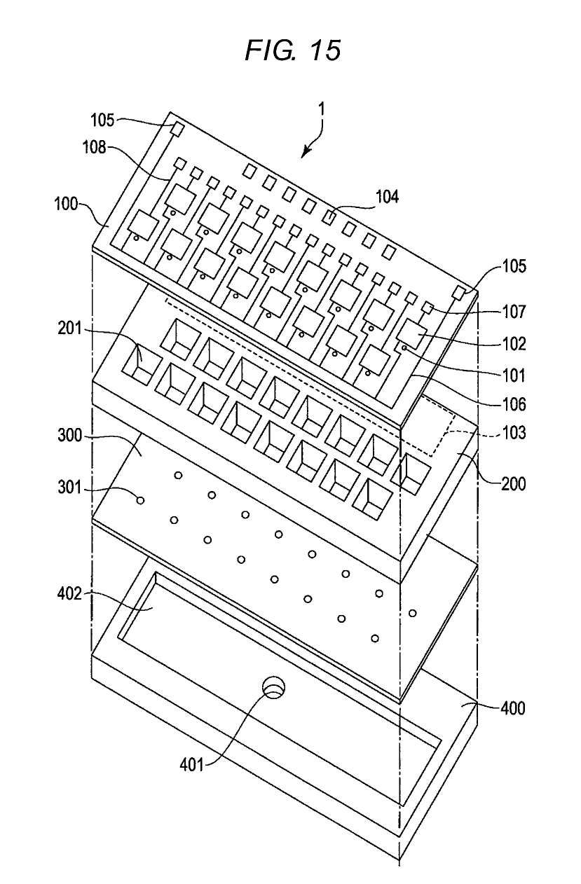

Next, description will be given of the seventh embodiment with reference to FIG. 15. FIG. 15 is an exploded perspective view showing the ink jet head 1 according to the seventh embodiment. In the seventh embodiment, the nozzle 101 is arranged in a different position to the actuator 102, and the actuator 102 and the pressure chambers 201 are formed in rectangular shapes. The width of the actuator 102, for example, is 250 μm. The length of the actuator 102, for example, is 220 μm.

In the same manner as the second embodiment, the ink discharge pressure can be increased in the ink jet head 1 of the seventh embodiment. In addition, in the same manner as the fifth embodiment, poor precision of the ink discharging position caused by poor patterning can be suppressed in the ink jet head 1.

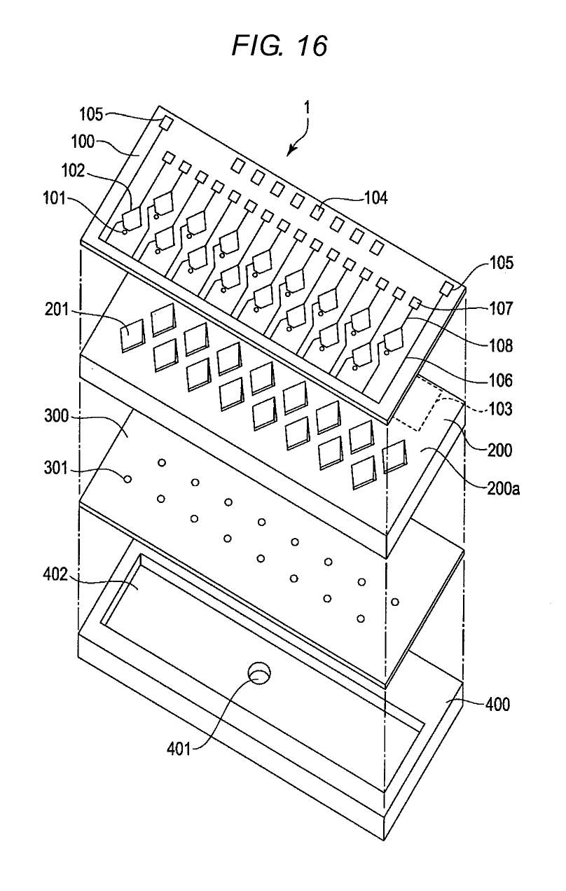

Next, description will be given of the eighth embodiment with reference to FIG. 16. FIG. 16 is an exploded perspective view showing the ink jet head 1 according to the eighth embodiment. In the seventh embodiment, the nozzle 101 is arranged offset from the position of the actuator 102, and the actuator 102 and the pressure chamber 201 are formed in rhombic shapes. The width of the actuator 102, for example, is 170 μm. The length of the actuator 102, for example, is 340 μm.

In the same manner as the third embodiment, the actuator 102 is easily arranged in a zigzag shape in the ink jet head 1 of the eighth embodiment. In addition, in the same manner as the fifth embodiment, poor precision of the ink discharging position caused by poor patterning can be suppressed in the ink jet head 1.

According to at least one of the inkjet heads described above, the drive circuit is provided on the mounting surface of the substrate to which the vibration plate is fixed. Accordingly, the distance between the drive circuit and the first or the second electrode can be shortened, and the wiring resistance can be reduced. Therefore, the attenuation of a signal emitted from the drive circuit and the power consumption during the ink discharging can be reduced. In addition, even if the drive circuit is provided on the substrate, the protective film facing a medium such as recording paper can be formed in a planar manner. Therefore, the distance between the medium and the ink jet head can be shortened, and the ink discharge precision can be maintained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An ink jet head comprising:
a substrate including amounting surface and a pressure chamber open to the mounting surface;
a vibration plate including a first surface fixed to the mounting surface of the substrate and covering the pressure chamber, and a second surface opposite the first surface;
a first electrode formed on the second surface of the vibration plate;
a piezoelectric body overlapping the first electrode;
a second electrode overlapping the piezoelectric body;
a protective film provided on the second surface of the vibration plate and covering the first electrode, the piezoelectric body and the second electrode;
a nozzle in communication with the pressure chamber, formed on at least one of the vibration plate and the protective film, and configured to discharge ink, and
a drive circuit provided on the mounting surface of the substrate and configured to apply a drive voltage to the first electrode or the second electrode to deform the piezoelectric body and to change a volume of the pressure chamber.

2. The ink jet head of claim 1,
wherein the drive circuit includes a plurality of semiconductor devices formed on the substrate.

3. The ink jet head of claim 2,
wherein the vibration plate covers the drive circuit.

4. The ink jet head of claim 3,
wherein the vibration plate separates the plurality of semiconductor devices from each other.

5. The ink jet head of claim 4,
wherein the semiconductor devices include a CMOS transistor.

6. The ink jet head of claim 1, wherein;
the vibration plate includes an aperture extending therethough having a perimeter larger than the perimeter of the nozzle; and
the protective film extends inwardly of the aperture in the nozzle plate an forms the walls of the nozzle.

7. The ink jet head of claim 1, wherein the nozzle extends through, and is spaced from, the piezoelectric body.

8. The ink jet head of claim 1, wherein the nozzle is positioned adjacent to, and spaced from, the piezoelectric body.

9. The ink jet head of claim 1, wherein the piezoelectric body has a annular shape.

10. The ink jet head of claim 1, wherein the piezoelectric body has a rhombic profile.

11. The ink jet head of claim 10, wherein the piezoelectric body has a rectangular profile.

12. The ink jet head of claim 1, wherein the Young's modulus of the protective film is less than the Young's modulus of the vibration plate.

13. The inkjet head of claim 12, wherein the protective film is thicker than the thickness of the vibration plate.

14. An inkjet device, comprising:
a body having an ink reservoir having an open end;
a vibration plate having a nozzle extending therethrough in fluid communication with the ink reservoir; a piezoelectric drive element attached to vibration plate;
a protective film overlying the piezoelectric element and the nozzle plate, the protective film having a different bending characteristic than the vibration plate;
a drive circuit formed on the body; wherein,
the protective film overlies the drive circuit.

15. The ink jet device of claim 14, wherein the drive circuit is an integrated circuit.

16. The ink jet device of claim 15, wherein the body comprises silicon.

17. The ink jet device of claim 14, wherein the vibration plate and protective film form opposed convex-concave surfaces when a current parallel to the grain of the piezoelectric element is passed therethrough, and
the maximum convex projection of the nozzle plate is less than the maximum convex projection of the protective film.

18. A method of providing an ink jet from a reservoir of ink, comprising;
providing a thin plate capable of being flexed, and having a nozzle formed therethrough, adjacent a body having an ink reservoir such that the nozzle is in fluid communication with the ink reservoir;
providing a piezoelectric layer interposed between a first and a second electrode, on a surface of the thin plate;
providing a ground path to the first electrode;
forming an integrated circuit on the body;
covering the integrated circuit with the thin plate;
covering the thin plate with a protective film having a stiffness property different from that of the thin plate, on the side of the thin plate opposed to the ink reservoir; and
flowing a current from the integrated circuit, through the piezoelectric layer and to ground, thereby causing the piezoelectric layer to deform the thin plate in the direction of the ink reservoir.

19. The method of claim 18, further including the step of providing the protective film in the nozzle opening through the thin plate.

20. The method of claim 18, wherein the integrated circuit includes at least one doped region formed within the body.
